(19) United States
(12) Patent Application Publication
(10) Pub. No.: US 2009/0094821 A1
(43) Pub. Date: Apr. 16, 2009

(54) PROCESS FOR FABRICATING A CLOTH-LIKE HEATING ELEMENT WITH TWO PAIRS OF ELECTRICAL CONDUCTORS AND PARALLEL CIRCUITS

(76) Inventor: Tae Moon Kim, Pusan (KR)

Correspondence Address: IPLA P.A., 3580 WILSHIRE BLVD., 17TH FLOOR, LOS ANGELES, CA, 90010, US

(21) Appl. No.: 11/871,849

(22) Filed: Oct. 12, 2007

(51) Int. Cl. H05B 3/10

(52) U.S. Cl. 29/611

(57) ABSTRACT

The present invention is a process for fabricating a cloth-like heating element with two pairs of electrical conductors and parallel circuits which are formed via a severing process. A pair of electrical conductors, which looks as a twin belt aligned in parallel, is fabricated on both edges of the heating element by the weaving process; Severing predetermined portions of the inner electrical conductor in order to increase the electrical resistance of heating wires, the pertinent heating wires are connected in series circuitry with each side of the outer electrical conductors; and the heating element is completed when the said process of series linkage is continuously carried out in parallel alignment in accordance with predetermined design.

### BACKGROUND OF THE INVENTION

1. Technical Field

The present invention relates generally to a cloth-like heating element with two pairs of electrical conductors and parallel circuits which are formed via a severing process.

2. Related Art

An existing cloth-like heating element, Korean Utility Model Registration #1100067, is issued to the same applicant as the present invention, and its functions are as follows:

According to predetermined design, a great number of resistance heating alloys, which are drawn down to fine thickness, and are hereinafter called heating wires, is arranged at some intervals between individual threads which wind up on the loom's beam, while a fine copper wire is used as the weft.

Through the weaving process, a loom weaves heating wires and copper wires at both edges of the heating element, thereby completing the cloth-like heating element with a parallel structure.

The above mentioned cloth-like heating element, which has the benefits induced by parallel circuitry, is only in use with very low voltages (Dc12V, 24V), because in case of increasing the number of heating wires for the purposes of enhancing durability or heat balance of the heating element, the input voltage for the heating element must be relatively decreased.

This is in accordance with Ohm's law, which states that electrical resistance is inversely proportional to the number of heating wires connected in parallel.

Therefore, the above mentioned heating element cannot function under high voltages (AC100V, 220V), which is a fatal weakness.

### SUMMARY OF THE INVENTION

The present invention seeks to overcome the above stated problems by providing a cloth-like heating element with two pairs of electrical conductors and parallel circuits which are formed via a severing process, of which the production method is summarized as follows:

A pair of electrical conductors, which consists of an inner electrical conductor and an outer electrical conductor, resembles a twin belt aligned in parallel and is stitched into both edges of the heating element via the weaving process;

Severing the predetermined portions of the inner electrical conductor and the heating wires, which interlock between the inner electrical conductor and the outer electrical conductor in order to increase the electrical resistance of the heating wires, the pertinent heating wires are connected in series linkage with each side of the outer electrical conductors, thereby raising the electrical resistance in proportion to its extended length; and

In accordance with the predetermined design, the said process of series linkage is continuously carried out, whereby all the heating wires of the heating element are connected with each side of the outer electrical conductors in parallel, thereby completing the heating element with parallel circuits.

### BRIEF DESCRIPTION OF THE DRAWING

The drawings described herein are for illustrative purposes only and are not intended to limit the scope of the present invention in any way.

FIG. 1 is a perspective of the heating element with two pairs of electrical conductors in accordance with the present invention.

FIG. 2 is an illustration of the severing and connecting process in accordance with the present invention.

### DETAILED DESCRIPTION OF THE INVENTION

The best mode for implementing the present invention will be described hereinafter in detail with reference to the drawings.

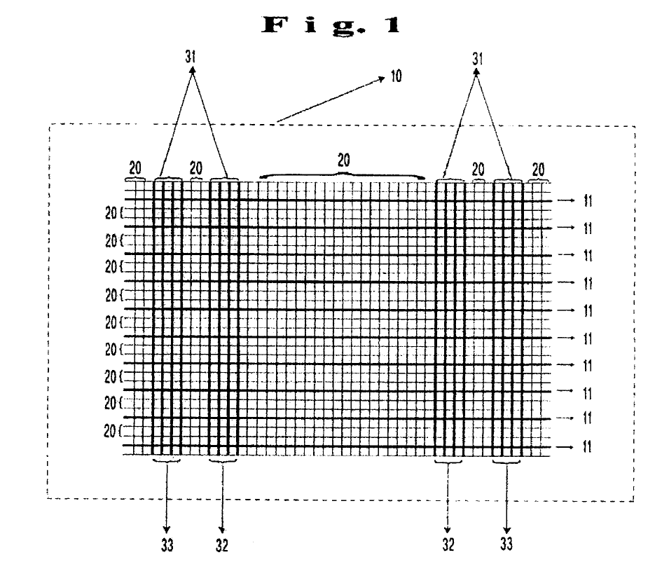

As Shown in FIG. 1, from both sides, appropriate amounts of threads 20, which are used in binding the edges and waste selvedge of the heating element, are inserted into the heddles of the loom, and then, appropriate amounts of electrical conductive alloys, which are drawn down to fine thickness, hereinafter called conductive wires, are continuously inserted into the heddles in accordance with the load capacity of the electrical current.

For example, if the load capacity is 500 Watts, the frictional damage by the reed of the loom should be taken into account, and for more reliable coupling with the heating wires 11, 7 strands of 0.08 mm conductive wires are inserted 16 times into the heddles of the loom, and then an approximately 15 mm gap, which is filled with threads 20, is formed continuously in order to have a space for the severing process, after which the 7 strands of 0.08 mm conductive wires are continuously inserted 16 times into the heddles of the loom, and the numerous threads 20 are continuously inserted into the heddles of the loom between the both sides of inner conductive wires 32, thereby completing all the preparatory stages of the weaving process.

Finally, a pair of electrical conductors 31 is stitched into both edges of the heating element 10 while the weaving process is running.

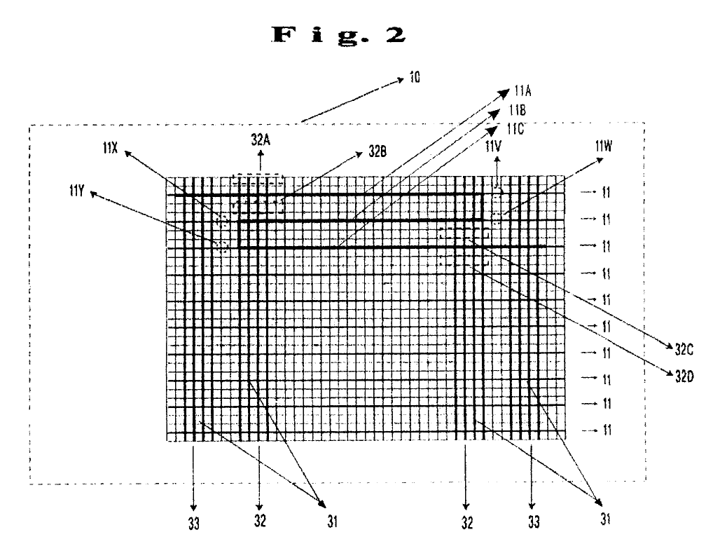

Referring to FIG. 2, the heating wires 11A, 11B and 11C are perfectly connected in series with each side of the outer electrical conductors 33 when the 32A, 32B, 32C and 32D of the inner electrical conductors 32 and the 11V, 11W, 11X and 11Y of the heating wires that interlock between the inner electrical conductor 32 and the outer electrical conductor 33 are severed.

Naturally, the severing process can be performed easily via piercing with a press mold.

By repeating the above mentioned process of series linkage according to the predetermined design so that all the heating wires are linked in parallel with the outer electrical conductors 33, the present invention, which has strong points as follows, is completed.

The heating element 10 with parallel circuits can be hooked to the electrical power source of voltage AC100V or 220V.

Even if one portion of the heating wires or some portion of the heating element malfunctions, the functions of the heating element will not entirely break down.

Even if the heating wires fracture or are severed during use, the malfunction will theoretically pose no danger of overheating to the user, because the electrical resistance of said heating element will be increased in accordance with Ohm's Law.

The method of increasing the electrical resistance of heating wires could be acquired easily by utilizing the above mentioned piercing process, which would never need other methods of connection such as soldering or harnessing terminals.

### EXAMPLE 1

To provide concrete explanations, numerical formulas and illustrations are shown as follows:

It is presumed that the heating element is made with the following conditions.

Conditions are:

Input voltage of 220 V;

Load capacity of 500 Watts;

Heating area of 120 cm (Width), 180 cm (Length); and

Electrical resistance of heating wire is 719 Ohms per 1 m.

For the purpose of enhancing the durability and heat balance of the heating element, the heating wires are continuously arranged 1 cm apart.

Hence, 121 heating wires can be aligned to fit the 120 cm width of the heating element.

120 cm÷1 cm+1 cm=121 strands

The electric resistance of each heating wire is 1294 Ohms.

1.8 m×719 Ohms=1294 Ohms

The total electric resistance of the heating element is approximately 97 Ohms.

R=220×220÷500 (cf. P=V²/R) R=96.8 Ohms

There are many methods to produce the heating element with 97 Ohms with use of 121 heating wires, each of which the resistance is 1294 Ohms.

But, according to experience, the best way to enhance the durability or heat balance of the heating element is to increase the number of heating wires with parallel linkage as much as possible and, to increase the number of heating wires with series linkage as least as possible.

Hence, when the 32A, 32B, 32C and 32D of the inner electrical conductors 32 and the 11V, 11W, 11X and 11Y of the heating wires that interlock between the inner electrical conductor 32 and the outer electrical conductor 33 are severed, the 11A, 11B and 11C of heating wires are perfectly connected in series with each side of the outer electrical conductors 33, and accordingly, it's electric resistance is 3882 Ohms.

1294 Ω×3 strands=3882 Ω

Hence, repeating the above mentioned process of series linkage 40 times, the heating element, of which electric resistance is 97 Ohms, is completed.

1÷X÷3882 Ω=97 Ω

X=40 times

Reference; the reciprocal of the equivalent resistance is the sum of the reciprocals of the individual resistances

[1/R_{equivalent}=1/R₁+1/R₂+1/R₃ . . . 1/Rn]

We claim:

1. A process for fabricating a cloth-like heating element with two pairs of electrical conductors and parallel circuits, comprising:
a) A pair of electrical conductors, which consists of an inner electrical conductor and an outer electrical conductor, is fabricated onto both edges of the heating element by the weaving process;
b) predetermined portions of the inner electrical conductor and the heating wires, which interlock between the inner electrical conductor and the outer electrical conductor, are severed in order that the pertinent heating wires are connected in series circuits with each side of the outer electrical conductors; and
c) In accordance with the predetermined design, the said process of series linkage is continuously carried out, whereby all the heating wires of the heating element are connected with each side of the outer electrical conductors in parallel alignment.

2. A process of claim 1, wherein said predetermined portions are defined by sections which are eliminated in order to link predetermined heating wires into series circuits.

3. A process of claim 1, wherein said pertinent heating wires are defined by the severed and remaining heating wires for the purpose of series linkage.

4. A method of increasing the electrical resistance of heating wires via the severing process of electrical conductors.

5. A method of claim 4, wherein said electrical conductors comprise all sorts of the electrical conductors which are formed via a weaving process.
